(19) United States
(12) Patent Application Publication
(10) Pub. No.: US 2006/0021721 A1
(43) Pub. Date: Feb. 2, 2006

(54) Curved window shade with inside spring support

(75) Inventors: Herbert Walter, Ebersbach (DE); Melf Hansen, Gondelsheim (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: BOS GmbH & Co. KG, Ostfildern (DE)

(21) Appl. No.: 11/191,703

(22) Filed: Jul. 28, 2005

(30) Foreign Application Priority Data
Jul. 29, 2004 (DE) 10 2004 036 948.8

(51) Int. Cl. E06B 9/56

(52) U.S. Cl. 160/315; 242/371

(57) ABSTRACT

A window shade particularly adapted for use with curved windows of motor vehicles. The window shade comprises a curved winding shaft that includes a tubular axle, a plurality of axially connected shaft sections mounted on the axle for relative rotational movement, and a winding spring supported within the axle having one end fixed to the axle and the other end secured to a shaft section. In this way, assembly of the window shade is facilitated and the spring is supported within the axle without rattling noises.

### FIELD OF THE INVENTION

The present invention relates generally to window shades, and more particularly to window shades for use on motor vehicle windows.

### BACKGROUND OF THE INVENTION

Modern automobile bodies are trending away from the use of flat surfaced rear windows toward rear windows with a strong curvature. Such rear windows are difficult to shade with conventional window shade assemblies that have a straight winding shaft for the window shade web. The straight window shade lies, so-to-speak, like a bowstring in front of the strongly curved rear window, and accordingly, has a large separation from the middle of the window.

A correspondingly curved extraction slit in the window shade housing does not remedy this problem. The curved extraction slit would, at best, lead to different path lengths for individual sections of the shade web between the slit and the winding shaft. The consequence is an undesired puckering and slack areas that hang loose.

Efforts, therefore, are being made to create curved winding shafts, such shown, for example, in DE 103 38 900 A1. With the known construction, the winding shaft that is connected to the shade web consists of a number of straight shaft sections, which are coupled to one another in a stationary manner. The shaft sections sit jointly on a curved axle so they cannot rotate. The axle is clamped at one end in order to anchor the one end in the circumferential direction and in the axial direction. The other end is supported by means of a cap which is supported on the axis in a rotatable manner, wherein a spring rod leads through the cap and is fixed rigidly outside the axle. The spring rod carries a rigid spring support on its end lying in the axle, whereas the outside spring support is anchored on the cap.

In order to wind up the shade web on the winding shaft, about 10 to 15 rotations of the shaft are required. In order for the pre-stress of the spring not to be depleted after as many as 10 to 15 rotations of the winding shaft, a relatively long spring must be used and appropriately pre-stressed. A flat spring characteristic can be achieved by the use of such long spring, wherein 10 to 15 rotations of the winding shaft does not prevent the proper spring stroke being reached at either end of its movement. The spring rod also must be correspondingly long, which leads to problems with the installation in the curved axle.

### OBJECTS AND SUMMARY OF THE INVENTION

It is an object of the invention to provide a window shade that is simpler to install and use in curved windows, such as on curved windows in modem motor vehicles.

In carrying out the invention, the present window shade has a curved axle anchored rigidly at one end. The axle is tubular, at least at one end. The winding shaft is supported on the axle so that it can rotate, with the shaft being composed of at least of one shaft section and an end cap. The cap is simultaneously part of the support device for the axle and support for the spring. The cap is rotatably seated on corresponding support and thus restrains the free end of the axle in a radial direction.

The stationary spring support is seated in the tubular sectional winding shaft. In this way, the axle itself becomes the stationary support for the spring motor, and the spring rod existing in the prior art can be illuminated. Since the spring that forms the spring motor is flexible, it can adapt arbitrarily to the curvature of the axle. In particular, it can fit against the inside of the curvature of the axle, which helps reduce rattle noises. Constrained positions between the spring and the axle and the axle rod, as is the case in the prior art, are avoided.

The axial pre-stress which can be produced by the spring motor is simultaneously used to pre-stress the tubular winding shaft, together with the cap, in the axial direction. The individual shaft sections lie one against the other, free from play. An abutment is advantageously provided on one end of the rigid axle, against which the adjacent shaft section is pressed as a result of the pre-stress force. Axial locking of the shaft sections with respect to one another in this way becomes superfluous.

In the simplest case, the abutment can be formed by a flange which is produced by compressing the tubular axle. In order to anchor the tubular axle in a stationary manner, it is appropriately pressed at its end to form a fastening flap.

The cap, which is used to transfer the force of the spring motor to the shaft sections can have either the shape of a flat disk with corresponding entraining teeth for the shaft sections, or a cap with a base and a shaped collar with which it is itself supported on the outer periphery of the axle. The cap is provided on its side adjacent to the rigid axle with a spring support, in which a helical spring used as the spring motor is anchored free of rotational play and axially secure. The stationary spring support consists of an insertion piece which is inserted in the rigid axle and, for example, may be pressed in place by crimping.

Other objects and advantages of the invention will become apparent upon reading the following detailed description and upon reference to the drawings, in which:

### BRIEF DESCRIPTION OF DRAWING(S)

FIG. 1 is a partial perspective of a motor vehicle showing an inner side of a rear window having a window shade in accordance with the invention;

FIG. 2 is an enlarged depiction of the roller blind shown in FIG. 1;

FIG. 3 is an axial fragmentary section of one end of the wind up shaft for the illustrated roller blind; and

FIG. 4 is an axial section of the opposite end of the wind up shaft of the illustrated roller blind.

While the invention is susceptible of various modifications and alternative constructions, a certain illustrated embodiment thereof has been shown in the drawings and will be described below in detail. In should be understood, however, that there is no intention to limit the invention to the specific form disclosed, but on the contrary, the intention is to cover all modifications, alternative constructions and equivalents falling within the spirit and scope of the invention.

### DETAILED DESCRIPTION OF THE PREFERRED EMBODIMENT

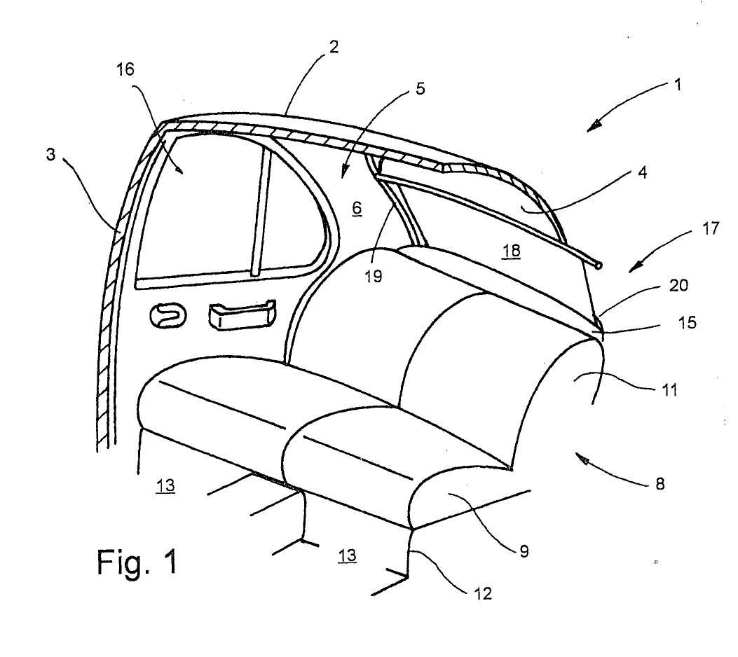

Referring now more particularly to FIG. 1 of the drawings, there is shown the inside of a passenger car having a rear window roller shade in accordance with the invention The passenger car includes a body section 1 that includes a roof 2 from which a B-column 3 laterally extends downward to a floor group. The roof 2 transforms into a rear window 4 on its rear edge. The rear window 4 laterally ends on a C-column 5 that is spaced apart from the B-column 3. The C-column 5 carries an inside lining 6.

As will be understood by persons skilled in the art, between the B-column 3 and the C-column 5, a right rear door 7 is conventionally hinged to the B-column 3. A rear bench 8 consisting of a seat 9 and a back rest 11 is arranged at the height of the right rear door 7. The rear seat 9 lies on a base surface 12 that forms part of the floor group, wherein a certain leg room 13 is created in this floor group in front of the rear seat 9. At the level of the upper edge of the rear seat back support 11, a rear window shelf 15 extends to the lower edge of the rear window 4. The right rear side door is provided with a side window 16 in the manner usual for sedans.

A rear window roller shade 17 is mounted on the inner side of the rear window 4. The roller shade 17 has a strip shaped web 18 mounted for movement between lateral guide rails 19, being depicted in FIG. 1 in partially extended position. The guide rails 19 begin at a rear window shelf 15 arranged behind the rear back seat support 11 and extend adjacent to the lateral window edge. The web 18 extends out of a continuous slot or slit 20 arranged in the rear window shelf 15. The slit 20 is curved in a manner approximately similar to the curvature of the rear window 4.

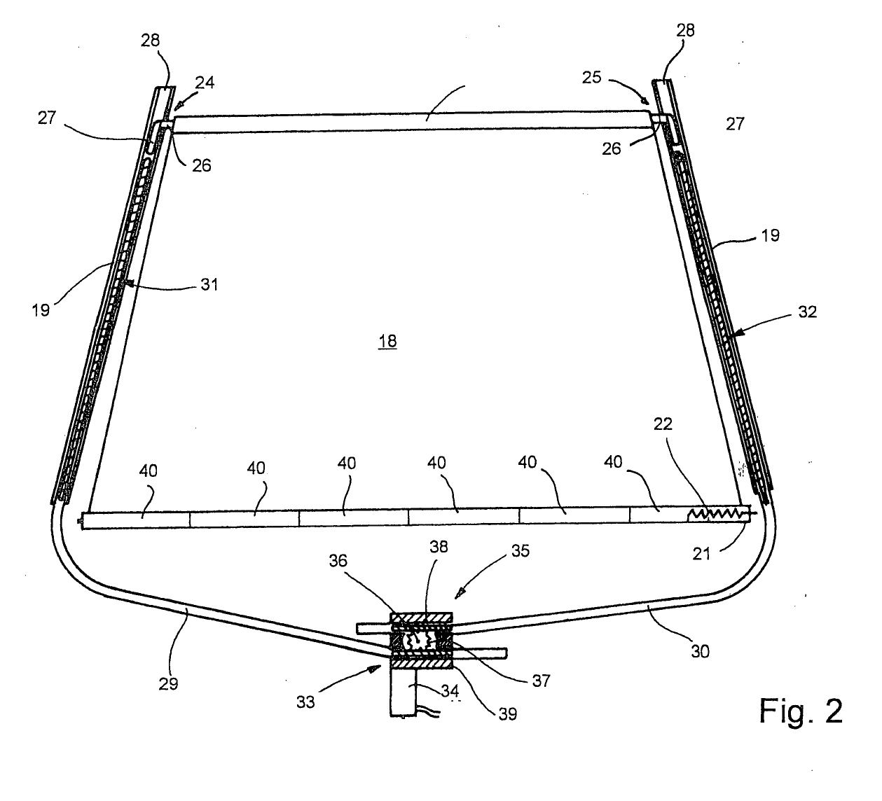

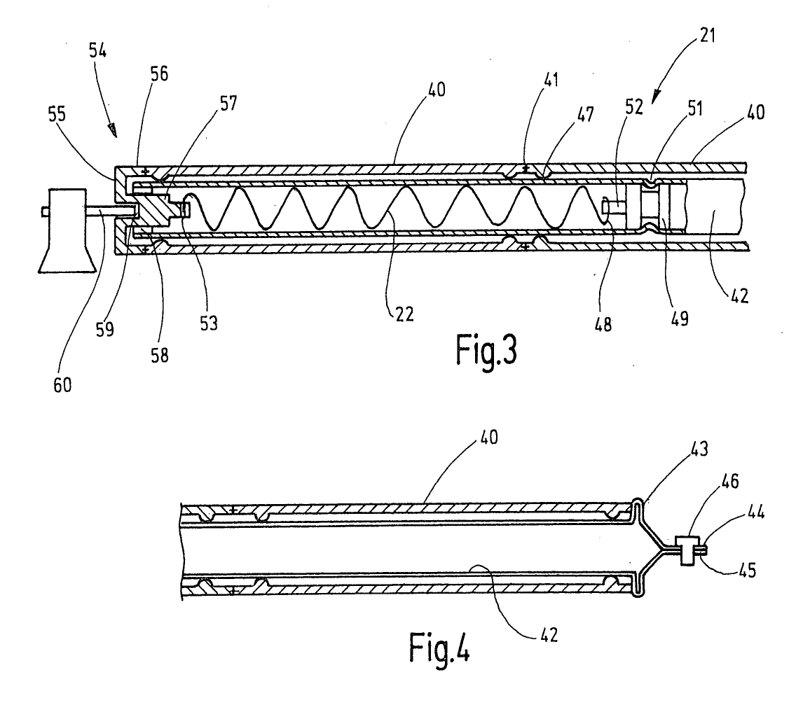

The roller shade 17, the basic design of which is shown in FIG. 2, has a winding shaft 21 rotatably supported underneath the rear window shelf 15, with one edge of the web 15 being fixed to this winding shaft. The winding shaft 21 is pre-stressed in the wind-up direction of the web 18 on the winding shaft 21 with the aid of an appropriate spring drive 22. The spring drive 22 in this case is a coil or helical spring, one end of which is rigidly anchored on the vehicle body and the other end of which is fixed in the winding shaft 21. The winding shaft 21 has a curvature corresponding to the extraction slit 20.

The shade web 18 has an approximately trapezoidal shape and is formed with a tubular loop 22 on an end opposite the winding shaft 21. A draw-out profile or pull rod extends through the tubular loop 22 and telescopically supports end guide pieces 24, 25 in its interior. The end pieces 24, 25 contain a neck part 26 of smaller diameter than an adjacent guide element 27 that has the shape of a short cylindrical section. The guide elements 27 move in the guide rails 19 arranged adjacent opposite lateral edges of the rear window 4.

Since both the winding shaft 21 as well as the profile of extraction slit 20 are curved in the same manner, the pulled-out shade web 18 defines a curved surface whose generatrix is a straight line. The shade web 18 preferably does not brush against the edges of the extraction slit 20.

Each guide rail 19 has a guide groove 28 that opens in the direction of the web 18. The lower end of each guide rail 19 is connected to a guide tube 29, 30, in which two bendable thrust elements 31, 32 are guided in a buckle-proof fashion. The bendable thrust elements 31, 32 comprise so-called Suflex shafts. They include a cylindrical core that is surrounded by a helically extending rib, which defines a flexible toothed rack engageable with peripheral gearing.

The guide tubes 29, 30 connect the guide rails 16 to a drive motor 33. The drive motor 33 comprises a permanently excited D.C. motor 34 and a gear unit 35 having an output shaft 36 with a spur gear 37 fixed thereon. The gear 37 positively meshes with both thrust elements 31, 32. These thrust elements 31, 32 tangentially extend past the cylindrical gear 37 on diametrically opposite sides and are guided in corresponding bores 38, 39 for this purpose.

When the drive motor 33 is actuated, the thrust elements 31, 32 are selectively extended or retracted, with the guide pieces 24, 25 following the movement of the thrust elements 31, 32. These guide pieces are held against the free ends of the thrust elements 31, 32 in the guide grooves 27 with the aid of a spring motor 22 acting on the web.

In accordance with the invention, the winding shaft is composed of a plurality of interconnected tubular shaft sections mountable on a common axle for positioning in conformed relation to the curvature of the automobile window with which the window shade is used. In the illustrated embodiment, the winding shade comprises a plurality of tubular sections 40 which are disposed in axial end to end in relation to each other. The tubular shaft section 40 are positively coupled to one another at intersections 41. For this purpose, the shaft sections 40 have frontal axial lugs between which complimentary shaped recesses or gaps are formed so that the lugs on one end of a shaft section can mesh with the recesses in the end of the adjacent shaft section 40. At the same time, the positive connection allows the individual shaft sections 40 to tilt relative to one another, thus approximating the desired curved path of the winding shaft similar to a polygon.

In order to define the desired curved path of the winding shaft, the shaft sections 40 are positioned one next to the other on a tubular axle 42. The axle 42 is axially compressed or deformed at one end to define an outwardly projecting radial flange 43, as depicted in FIG. 4, which defines an abutment for the shaft section 40 at that end of the winding shaft. For enhanced strength, the wall material forming the tubular axle is doubled in the area of the flange 43.

Toward the right side of the flange 43, as viewed in FIG. 4, the remaining tubular part of the axle is pressed flat, whereby a flat fastening plate is formed. The fastening plate has an opening 45 for a fastening element 46, for example, a screw, rivet, or the like. Hence, both the abutment flange 43 and the fastening plate 44 can be formed by mechanical deformation of the one piece tubular axle 42.

In order for the tubular sections 40 on the curved axle 42 to have as little play as possible, but on the other hand, not jam by reason of the curvature, the tubular shaft sections 40 are provided with inwardly deformed bumps or protrusions 47. The bumps or protrusions 47 preferably lie in circumferentially spaced groups at longitudinal intervals.

One group of these bumps or protrusions 47 is provided adjacent each end of the shaft sections 40. In this way, the tubular shaft section 40 can lie elevated between the bumps 47 at its two extreme ends and be in contact with the tubular axle 42 only via the bumps 47. A curvature of the tubular axle in the area between the ends of the tubular shaft sections 40 therefore does not lead to jamming. The individual tubular sections 40 may be shaped in the manner shown in DE 103 38 900 A1, the disclosure of which is incorporated herein by reference.

The spring motor 22 may comprise a helical spring. The helical spring 22 is anchored at its end in a spring support or abutment 49 which is inserted into the tubular axle 42. The abutment 49 is secured in place by means of a crimp 51 in the axle so that the abutment can neither move axially or rotatably with respect to the axle 42. The spring support 49 in this case is provided in the area of the crimp 51 with a corresponding annular constriction. The spring support 49 carries a short journal 52 with a transverse hole into which the end of the spring 48 is anchored.

The other end 53 of the spring 22 is couple with a cup shaped cap 54. The cup shaped cap 54 includes a base 55 and a short inwardly extending collar 56. The collar 56 is provided with the same axle coupling tooth construction on its free end as the adjacent shaft section 40 for creating a similar positive axle coupling between the cup shaped cap and the adjacent shaft section 40.

Adjacent the end of the tubular axle 42, the base 55 of the cap 54 carries a journal shape prolongation or shaft 57 in which the end 53 of the spring 22 is secured. On the journal-shaped prolongation 57 there also is a bearing bushing 58 that ensures that the cup shaped cap 54 is supported with little play so that it can rotate in the tubular axle 42. On the outer axial end of the base 55, a blind borehole 59 is provided into which a bearing journal 60 projects.

As a result of the arrangement of the helical spring 22, the winding shaft 21 is pre-stressed in the wind up direction of the shade web 18. In order to produce a torque, the helical spring 22 is supported via the stationary spring support 49 in the body by means of the journal 52 fixedly held at the location. The other end of the helical spring 22 is coupled for rotation with the adjacent tubular shaft section 40 via the cup-shaped cap 54, which in turn is coupled with the shaft section 40 adjacent to it with little or no play. In this way, the torque produced by the helical spring 22 is transmitted to all shaft sections 40.

It can be seen that the helical spring 22 is anchored on the spring support 49 and the cup shaped cap 54 against relative axial and rotational movement. Appropriate positioning of the spring support 49 thus assures that the helical spring 22 not only produces the drive torque, but also exerts an axle force on the cup-like cap 54 pressing the sequence of tubular shaft sections 40 axially against one another. The reaction force is finally absorbed by the flange 43.

Since the cap 54 is supported, via the journal 57 and the bearing bushing 48, the little play in the tubular axle 42 and the stationary bearing journal 60 fits with little play in the blind borehole 59, the end of the tubular axle 40, which protrudes freely and is not directly secured to the body, is guided in a radial direction. All radial forces which are transmitted by the winding shaft 21 to the tubular axle 40 are introduced into the body, on one end directly via the plate 44, and on the other end, by means of the cup-shaped cap 54, which is rotatably supported.

As will be understood by one skilled in the art, in the present arrangement there is no necessity for a rod or the like to be conducted through the helical spring. Instead, the helical spring 22 can follow unhindered the curved path of the curved tubular axle 42. The curvature of the tubular axle inevitably guarantees that the helical spring 22 fits tightly against the inside wall of the tubular axle 40. Hence, vibrations of the vehicle will not vibrate the spring 2, which could induce rattling within the tubular axle.

From the foregoing, it can be seen that a window shade is provided with a curved winding shaft and a spring motor, with a spring support being fixed within and on the axle on which the individual segments of the winding shaft are supported so they can rotate. In this way, the mounting is facilitated and it is possible to place the spring against the wall of the axle to avoid rattling.

1. A window shade (17) for motor vehicles comprising an axle (42) curved substantially in the shape of an arc, said axial being non-rotatably fixed at one end and having an opposite free end that is tubular in shape, a window shade shaft (21) rotatably supported on the axle and including at least one tubular shaft section (40) whose inside diameter is larger than the outside diameter of the axle (42), a cap (54) connected to said opposite end of said shaft without relative rotational movement, a stationary support (60) for rotatably supporting said cap (54), a shade web (18) attached at one edge to said shaft (21) and having an edge (22) remote from the shaft adapted for relative movement with respect to the shaft for positioning adjacent a motor vehicle window, and a spring motor (22) for exerting a torque on said shade web (18) having one end fixed to said axle (42) and an opposite end connected to said cap for rotation with said cap and shaft relative to said axle (42).

2. The window shade of claim 1 in which said axle comprises a plurality of tubular shaft sections (40) disposed in abutting end when in relation to each other.

3. The window shade of claim 2 in which said shaft sections have inter-engaging lugs at opposite ends which permit positioning of the tubular shaft sections in arc while rotatably coupling the shaft sections together.

4. The window shade of claim 2 in which said spring motor biases said shaft sections in abutting end to end relation to each other.

5. The window shade of claim 1 in which said axle (42) has a continuous tubular shape.

6. The window shade of claim 1 in which said axle (42) has an abutment (43) for absorbing forces of said shade shaft (21) in an axial direction against the abutment (43).

7. The window shade of claim 6 in which said abutment (43) is a radial flange extending outwardly of the shaft formed by axle deformation of the axle (42).

8. The window shade of claim 1 in which said axle (42) has a flattened plate shaped flange (42) extending in an axial direction and which is fixed against rotation.

9. The window shade of claim 1 in which said cap (54) has a base (55) with a tubular collar extending inwardly toward said shaft.

10. The window shade of claim 9 in which said cap collar (56) is coupled to said shaft section (40) without rotation.

11. The window shade of claim 1 in which said cap (54) has a bearing bore hole (59) within which said support (60) extends for rotatably supporting said cap (54).
